(19) United States
(12) Patent Application Publication
(10) Pub. No.: US 2025/0336175 A1
(43) Pub. Date: Oct. 30, 2025

(54) LEARNING DATA GENERATION SUPPORT DEVICE, MOVEMENT CONTROLLER, ARTICLE ACQUISITION AND PLACEMENT SYSTEM, LEARNING DATA GENERATION SUPPORT METHOD, AND RECORDING MEDIUM

(71) Applicant: Konica Minolta, Inc., Tokyo (JP)

(72) Inventors: Tomoyoshi Yukimoto, Tokyo (JP); Yuki Higuchi, Tokyo (JP); Muralikarteek Gandiboyina, Tokyo (JP)

(73) Assignee: Konica Minolta, Inc., Tokyo (JP)

(21) Appl. No.: 19/191,662

(22) Filed: Apr. 28, 2025

(30) Foreign Application Priority Data
Apr. 30, 2024 (JP) 2024-073498

(51) Int. Cl. G06V 10/25; G06T 7/13; G06T 7/50; G06T 7/62; G06V 10/764; G06V 10/774

(52) U.S. Cl. CPC G06V 10/25; G06T 7/13; G06T 7/50; G06T 7/62; G06V 10/764; G06V 10/774

(57) ABSTRACT

Disclosed is a learning data generation support device, including a hardware processor that: extracts a first extraction region corresponding to a detection target from a captured image including the detection target; determines certainty that the first extraction region is accurate; determines the certainty with respect to the first extraction region determined to have the certainty equal to or higher than a reference from a different viewpoint; extracts, from a captured image including the first extraction region determined to have the certainty equal to or higher than the reference from the different viewpoint, a second extraction region corresponding to the detection target by a different method; determines certainty that the second extraction region is accurate; and determines the second extraction region which is determined to have the certainty equal to or higher than a reference as learning data of a machine learning model for extracting the detection target.

### BACKGROUND OF THE INVENTION

### Technical Field

The present invention relates to a learning data generation support device, a movement controller, an article acquisition and placement system, a learning data generation support method, and a recording medium.

### Description of Related Art

Conventionally, there is a technique in which a necessary part is appropriately picked up from a stack of parts by an arm or the like and is sent to a manufacturing and assembling process. An image recognition technology is used for the recognition of the part. A desired part is recognized from an image captured by the image capturer, and the position and the orientation of the arm are determined according to the position and the orientation of the part. A machine learning model is effective for such image recognition. The machine learning model performs learning using the captured image of the recognition target and the correct answer data indicating the correct shape, thereby improving the recognition accuracy.

However, in a case of a member which is three dimensionally positioned in various orientations, in particular, in a case where a shape is complicated, it is difficult to accurately generate correct answer data, enormous time and effort are required, and an influence of a skill level of a creator of the correct answer data is large. Therefore, it is difficult to simply obtain accurate correct answer data. On the other hand, Japanese Unexamined Patent Publication No. 2023-038990 discloses a technique in which correct answer data is mechanically initially generated, the reliability thereof is determined, and only correct answer data whose reliability is not high is artificially prompted to be confirmed or corrected.

### SUMMARY OF THE INVENTION

However, there is a problem that such a correction eventually requires the labor of a skilled person, and the degree of reduction in labor remains within a narrow range.

An object of the present invention is to provide a learning data generation support device, a movement controller, an article acquisition and placement system, a learning data generation support method, and a recording medium of a program, which can obtain correct answer data with less manpower.

To achieve at least one of the abovementioned objects, according to an aspect of the present invention, learning data generation support device reflecting one aspect of the present invention is a learning data generation support device, comprising a hardware processor that:
extracts a first extraction region corresponding to a detection target from a captured image including the detection target;
determines a certainty that the first extraction region is accurate;
determines the certainty with respect to the first extraction region determined to have the certainty equal to or higher than a reference from a different viewpoint from a viewpoint from which the certainty that the first extraction region is accurate is determined;
extracts, from a captured image including the first extraction region determined to have the certainty equal to or higher than the reference from the different viewpoint, a second extraction region corresponding to the detection target by a method different from a method by which the first extraction region is extracted;
determines a certainty that the second extraction region is accurate; and
determines the second extraction region which is determined to have the certainty equal to or higher than a reference as learning data of a machine learning model for extracting the detection target.

To achieve at least one of the abovementioned objects, according to another aspect of the present invention, learning data generation support method reflecting one aspect of the present invention is a learning data generation support method comprising:
first extracting that is extracting, from a captured image including a detection target, a first extraction region corresponding to the detection target;
first determining that is determining a certainty that the first extraction region is accurate;
second determining that is determining, for the first extraction region for which the certainty is determined to be equal to or more than a reference in the first determining, a certainty from a different viewpoint from the first determining;
second extracting that is extracting, from a captured image including the first extraction region for which the certainty is determined to be equal to or more than the reference in the second determining, a second extraction region corresponding to the detection target by a method different from the first extracting;
third determining that is determining a certainty that the second extraction region is accurate; and
learning data generating that is determining the second extraction region determined to have the certainty equal to or higher than a reference in the third determining as learning data of a machine learning model for extracting the detection target.

To achieve at least one of the abovementioned objects, according to another aspect of the present invention, recording medium reflecting one aspect of the present invention is a non-transitory recording medium storing a computer-readable program causing a computer to perform:
first extracting that is extracting, from a captured image including a detection target, a first extraction region corresponding to the detection target;
first determining that is determining a certainty that the first extraction region is accurate;
second determining that is determining, for the first extraction region for which the certainty is determined to be equal to or more than a reference in the first determining, a certainty from a different viewpoint from the first determining;
second extracting that is extracting, from a captured image including the first extraction region for which the certainty is determined to be equal to or more than the reference in the second determining, a second extraction region corresponding to the detection target by a method different from the first extracting;
third determining that is determining a certainty that the second extraction region is accurate; and
learning data generating that is determining the second extraction region determined to have the certainty equal to or higher than a reference in the third determining as learning data of a machine learning model for extracting the detection target.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram illustrating a configuration of an article acquisition and placement system;

FIG. 2 is a diagram illustrating an example of a target part;

FIG. 3 is a diagram illustrating an example of target parts to be bulked;

FIG. 4 is a diagram illustrating a flow of extraction of learning data and improvement of a machine learning model;

FIG. 5 is a flowchart illustrating a procedure of initial learning processing;

FIG. 6 is a flowchart illustrating a procedure of learning data candidate generation processing;

FIG. 7 is a flowchart illustrating a control procedure of learning data generation processing;

FIG. 8 is a flowchart illustrating a control procedure of model learning processing; and

FIG. 9 is a flowchart illustrating a control procedure of article placement control processing.

### DETAILED DESCRIPTION

Hereinafter, embodiments of the present invention will be described with reference to the drawings. However, the scope of the invention is not limited to the disclosed embodiments.

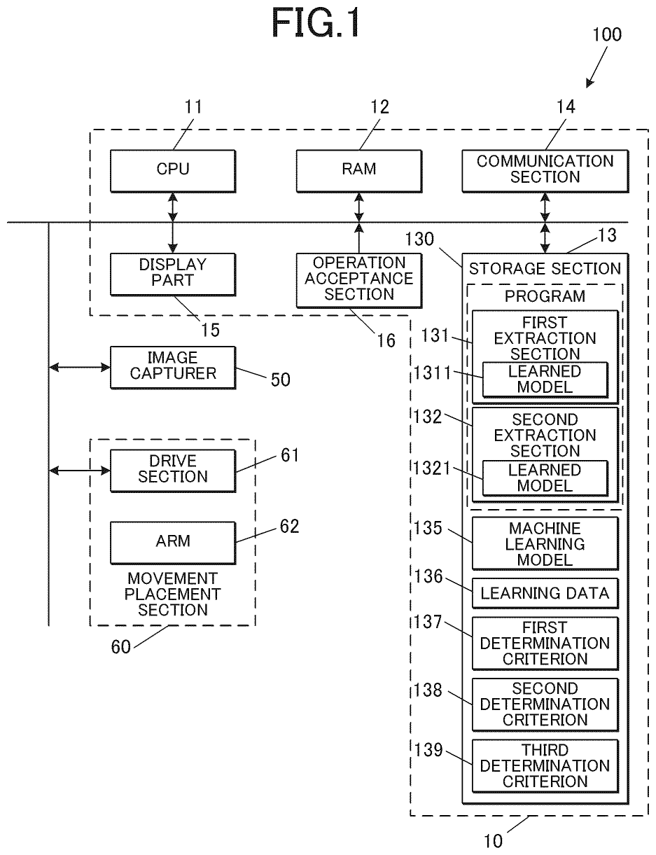

FIG. 1 is a diagram showing a configuration of an article acquisition and placement system 100 of the present embodiment.

The article acquisition and placement system 100 is a pick-and-place system in which a workpiece, which is a target article, is gripped by an arm 62 from parts loaded in bulk, moved to a specified position, and placed. The article acquisition and placement system 100 includes an information processing device 10 as a movement controller and a learning data generation support device, an image capturer 50, and a movement placement section 60 (movement operator).

The information processing device 10 is an electronic computing machine and may be a normal personal computer (PC). The information processing device 10 includes a central processing unit (CPU11) (controller), a random access memory (RAM12), a storage section 13, a communication section 14, a display part 15, and an operation acceptance section 16.

The CPU11 is a hardware processor that performs arithmetic processing and comprehensively controls the entire operation of the information processing device 10. The number of hardware processors may be one, or a plurality of hardware processors may operate independently or in parallel according to the application or the like.

The RAM12 provides a working memory space for the CPU11 and stores temporary data. The RAM12 is, for example, a DRAM, but is not limited thereto.

The storage section 13 is a nonvolatile memory that stores the program 130 and various types of setting data. The non-volatile memory may be, for example, a flash memory or a hard disk drive (HDD). The program 130 includes a first extraction section 131 (first extraction means) and a second extraction section 132 (second extraction means). The first extraction section 131 and the second extraction section 132 referred to herein are a function, a subroutine, a software module, or a combination thereof of the program 130. The first extraction section 131 includes a learned model 1311. The second extraction section 132 includes a learned model 1321. The machine learning model 135 is an image recognition program that specifies a detection target part (workpiece) from an image captured by the image capturer 50. The learning data 136 is data for causing the machine learning model 135 to learn. The first determination criterion 137, the second determination criterion 138, and the third determination criterion 139 are data representing conditions for acquiring the learning data 136. Learning of the machine learning model 135 and use of the learned machine learning model 135 by the program 130 will be described later.

The communication section 14 controls communication with an external device. The control target may be, for example, communication via the Internet line, a local area network (LAN), or a wireless LAN. The communication section 14 may include a connection terminal for performing direct communication, for example, a universal serial bus (USB) terminal.

The display part 15 includes, for example, a digital display screen. The display part 15 displays various information on the digital display screen under the control of the CPU11. The digital display screen may be, for example, a liquid crystal display screen or an organic electro-luminescent (EL) display screen.

The operation acceptance section 16 receives an input operation from the outside and outputs an operation signal corresponding to the content of the received input operation to the CPU11. The operation acceptance section 16 may include, for example, a pointing device such as a mouse or a touch screen. The operation acceptance section 16 may include a keyboard.

The display part 15 and the operation acceptance section 16 may be attached as peripheral devices to a main body of a computer including at least a CPU11. Furthermore, the storage section 13 might not be built in the housing of the computer. The storage section 13 referred to herein may include an external auxiliary storage device, a network storage, a cloud server, and the like. The RAM12 and the communication section 14 may also be externally attached to the main body of the computer as necessary.

The image capturer 50 images a plurality of parts (articles) loaded in bulk at a timing instructed by the CPU11 or periodically at a predetermined time interval, and outputs the captured image to the CPU11. The image capturer 50 is, for example, a digital image capturer having a CMOS sensor or the like. The imaging range, the magnification ratio, the focal length, and the like of the image capturer 50 may be fixed. Alternatively, the image capturer 50 may be able to move the imaging range based on the control of the CPU11.

The movement placement section 60 includes a drive section 61 and an arm 62. The movement placement section 60 grips and acquires a necessary part from the bulk by the arm 62, and moves and opens the part to a specified position, thereby arranging the part. For example, the movement placement section 60 may be able to place a part to be mounted at an appropriate position and orientation on a board on a conveyance belt, for example, in the middle of a product assembly process. The drive section 61 is a mechanism that moves and operates the arm 62 based on the control of the CPU11. The number of the arms 62 may be one or more. Note that the hardware processor that operates the drive section 61 may be different from the CPU11 hardware processor that comprehensively controls the entire operation. Furthermore, the hardware processor may not be a general-purpose processor, but may have a configuration specialized for the operation control of the arm 62.

Next, image recognition of a captured image by the image capturer 50 and learning thereof will be described.

The article acquisition and placement system 100 picks up a target article from bulk goods in a tray, a box, or the like, and places the target article in a determined position with a correct orientation. The target article may be, for example, a part (target part) to be incorporated in an assembly process. The material of the target article is not deformed in a normal bulk state or the like. The information processing device 10 detects a target part that is a detection target from the image captured by the image capturer 50 and accurately identifies the outer shape and orientation of the target part. The information processing device 10 determines, based on the identification result, the target part to be picked up, and causes the movement placement section 60 to perform an operation of picking up the target part. In bulk, a large number of parts are located one above the other. Therefore, most of the parts are partially or entirely covered with other parts. The arm 62 does not needs to excavate such parts. The article acquisition and placement system 100 may specify, as a detection target, only a target part that is located at the top and is not covered with another part.

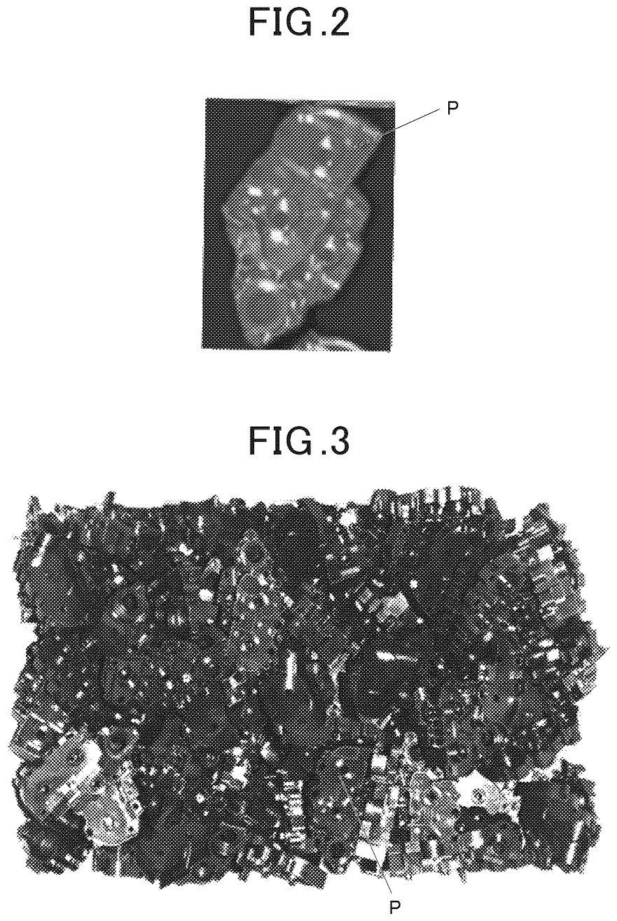

FIGS. 2 and 3 are diagrams illustrating examples of target parts to be loaded in bulk.

As illustrated in FIG. 2, the target part P may have a complicated shape having recesses and projections or holes depending on the function or the positional relationship with other parts. A large number of parts including such a target part P are stacked in bulk as illustrated in FIG. 3.

The target part may be in any orientation in the bulk. Further, the target part may be inclined with respect to the imaging surface. In particular, the front and back of the target part may be reversed. In accordance with these, a portion of the target part which is illuminated by external illumination or the like, a portion where reflected light is directed to the image capturer 50, or the like may change. The CPU11 accurately recognizes the position and the orientation of the target part on the basis of these, causes the arm 62 to grip an appropriate position of the target part, rotates the target part in a correct orientation, and mounts the target part at a specified position. The target part is not limited to one type. A plurality of types of parts may be set as target parts, and may be mounted at respectively 10 specified positions.

The information processing device 10 uses the machine learning model 135 to recognize a target part from a captured image. In order for the machine learning model 135 to accurately recognize the target part, the machine learning model 135 needs to be appropriately learned. The learning data 136 includes the captured image of the bulk and correct answer data that is an outline mask indicating the range of the target part in the captured image. The correct answer data may further include additional information indicating a classification as to which of the front and back surfaces of the target part is imaged. Furthermore, as described above, in a case where there are a plurality of types of target parts, the additional information includes the identification information on the plurality of types of target parts, correct answer data, that is, an annotation is conventionally obtained by a manual input operation on an image. However, it is difficult to perform an input operation of accurately tracing the contour of a part often having a complicated shape. In particular, experience and attentiveness are required for an operation of tracing a contour while reliably identifying the contour from other parts in bulk. Therefore, it takes a lot of time and effort to manually generate the learning data 136. In the present embodiment, correct answer data is generated with less manpower than in the past.

The information processing device 10 initially generates the simple learned models 1311 and 1321. Each of the learned models 1311 and 1321 has an image recognition algorithm related to segmentation for extracting the range of the target part. This image recognition algorithm outputs a distribution of probabilities of being the range of the target part, and binarizes the distribution of probabilities, thereby obtaining the range of the target part. A condition related to extraction accuracy is applied to the output results of these learned models 1311 and 1321, and the learning data 136 of the target part is collected. By generating and improving the machine learning model 135 by 30 the collected learning data 136, the detection accuracy of the target part by the machine learning model 135 is improved. In addition, as the learned models 1311 and 1321 are sequentially improved, the accuracy of collecting the learning data 136 also increases.

It is meaningless to take time and effort to generate learning data for learning and generating these learned models 1311 and 1321. The initial model of the learned model 1311 used to generate the first learning data may be obtained, for example, on the basis of captured images obtained by capturing a single target part (detection target) from a plurality of directions. In such a simple state, correct answer data can be easily obtained by using, for example, a simple contour detection algorithm. At this stage, accurate detection of the target part from the bulk is not required. Note that in a case where the learned model 1311 can extract the ranges of a plurality of types of target articles, learning based on the captured image of a single target article may be performed for each of the plurality of types of target articles.

The captured image of the single target part may be generated outside the article acquisition and placement system 100 and input to the information processing device 10. Alternatively, in a case where the imaging direction of the image capturer 50 can be changed, the image capturer 50 may be caused to image a certain target part alone while sequentially changing the orientation of the target part to a preset orientation using the arm 62.

For example, transfer learning may be applied to the learned model 1321 as an initial model. It is sufficient that the learned model that is the source is a model that has been learned so that some sort of segmentation is possible. The original object to be divided into regions by the learned model that is the basis is not particularly limited, but a material, an article, or the like that is as close as possible may be selected so that a negative transition is easily avoided. Regardless of the above, the transfer learning may also be applied to the learned model 1311.

The learned model 1321 may be able to determine not only the range of the target article but also the pattern inside the outline. The specific pattern may be settable based on a user's input in natural language. The learned model 1321 may be sequentially subjected to improvement learning by using the obtained learning data 136. Thus, the accuracy of detection of the target part by the learned model 1321 gradually increases.

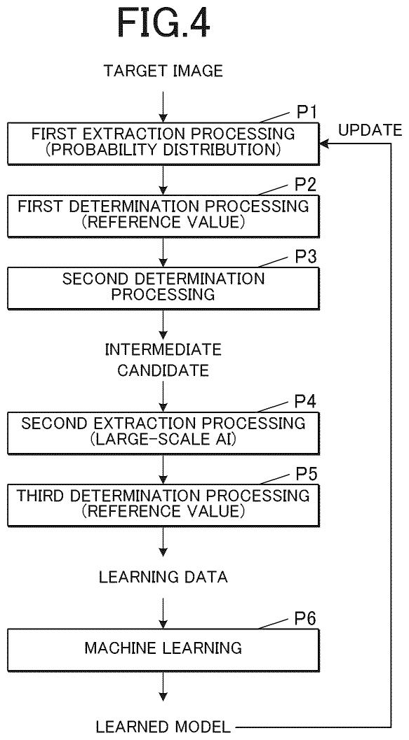

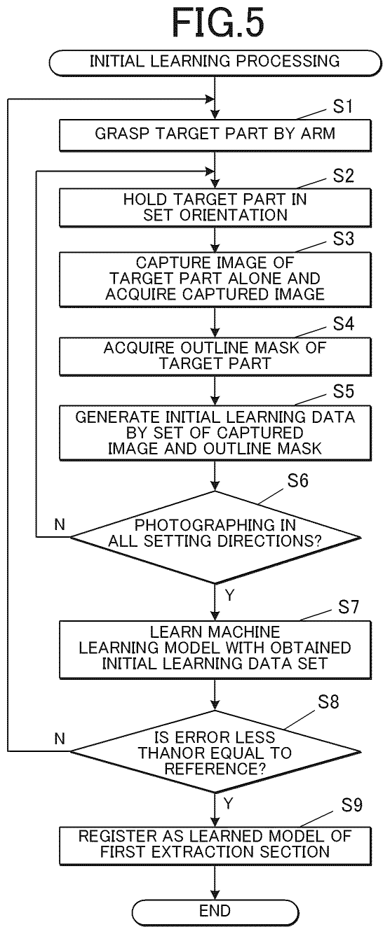

FIG. 4 is a diagram illustrating a flow of extraction of learning data and improvement of the machine learning model 135.

First, data of a target image is prepared. The target image is an image of the bulk at the predetermined position captured by the image capturer 50. However, the target image data may be an image prepared exclusively for learning as described later at an initial stage.

The target image is input to the first extraction section 131 in the first extraction processing P1. As described above, the first extraction section 131 includes the learned model 1311. In the first extraction processing P1, the range (first extraction region) of the target part in the target image is output together with its reliability. The reliability may be a conventionally known reliability score. The first determination process P2 (first determination means) excludes, based on the first determination criterion 137, a target image in which the certainty of the range of the detected target part is low. The first determination criterion 137 may be a lower limit value of an allowable reliability score or the like. Further, the second determination process P3 (second determination section) excludes a target image having a low possibility of being the detected target part among the target images not excluded in the first determination process P2 based on the second determination criterion 138.

The second determination criterion 138 defines, from a viewpoint different from the first determination criterion 137, in particular, a viewpoint unrelated to the machine learning model, whether or not the detection of the target part has certainty higher than or equal to a reference. For example, the second determination criterion 138 may be determined based on an item that can be recognized by a human, such as a visual shape feature such as a size or a contour shape of the extracted region in the captured image. That is, the visual shape feature referred to herein does not mean a multidimensional feature of four or more dimensions obtained using a neural network or the like. As described above, in the imaging of the bulk, the positional relationship between the image capturer 50 and the bulk, the imaging range of the image capturer 50, the magnification, and the like are fixed in principle, and thus the size of the imaged part is also substantially constant. Therefore, the difference in the actual size can be determined from the size on the captured image. Even when the enlargement ratio is changed, a difference in actual size can be determined according to the enlargement ratio. Furthermore, the visual shape feature may include, for example, a number of corners (vertices), a shape feature of a curve, an angular width of a corner or an arc, height information such as a protruding portion, and a feature on a contour such as a positional relationship between these shape parts. The similarities of these as a whole may be determined by, for example, pattern matching. Furthermore, the visual shape features may include the shapes, the numbers, the positional relationships, and the like of bumps and dips and holes that are obtained by edge detection or the like inside the outline. The image used for the determination in the second determination process P3 may be obtained in advance from a captured image of a single target part or a processed image thereof.

The target image that is not excluded in the first determination process P2 or the second determination process P3 is set as an intermediate candidate. The image of the intermediate candidate may be a range of a predetermined size (predetermined range) including a portion in which the target part is determined to be detected in the target image subjected to the first extraction processing P1. The predetermined size may be determined according to the size of the input image to the second extraction section 132 in the second extraction processing P4. The predetermined range may be defined with reference to, for example, the position of the centroid of the range of the extracted target part. The position of the centroid may be determined with an equal weight for all the pixels in the range of the target part. Alternatively, the position of the centroid may be defined with respect to a pixel on the contour of the target part. The position of the centroid is included in the predetermined range, and in particular, may be the center position thereof.

The intermediate candidate image is further used as an input image to be input to the second extraction section 132 in the second extraction processing P4. The second extraction section 132 includes the learned model 1321 as described above. The learned model 1321 is an image division model having a different structure from the learned model 1311. The learned model 1321 may use the same algorithm having a different number of layers from the learned model 1311. The number of hierarchies of the learned model 1321 is larger than that of the learned model 1311. Therefore, although the extraction accuracy of the second extraction section 132 can be higher than the extraction accuracy of the first extraction section 131, a larger amount of learning is required to improve the accuracy of extraction of target parts from bulk.

In the third determination processing P5 (third determination means), an example in which the range (second extraction region) of the target part extracted by the second extraction section 132 in the second extraction processing P4 has a low certainty of accuracy is excluded on the basis of the third determination criterion 139. The third determination criterion 139 may be a reference value of the reliability score similarly to the first determination criterion 137, but may be a value different from the first determination criterion 137. The remaining information on the target image and the range of the target part in the target image is used as the learning data 136. The first determination criterion 137, the second determination criterion 138, and the third determination criterion 139 may be variable depending on the situation.

The learned model 1311 of the first extraction section 131 has the same structure as the machine learning model 135. When machine learning of the machine learning model 135 is performed (P6), the learned model 1311 is also updated by the obtained model. Accordingly, the learned model 1311 is gradually improved, and the detection accuracy of the range of the target part by the machine learning model 135 is also improved in the generation range of the learning data 136.

As described above, in the present embodiment, two stage determination is performed, and the determination criterion includes the second determination criterion 138 that does not directly depend on the learned model. Accordingly, the accuracy of the learned model obtained by learning the machine learning model 135 using the learning data 136 in which the correct answer data is mechanically determined is improved compared to the single learned models 1311 and 1321. In particular, by performing a set of processing of updating the learned model 1311 with the learning result of the machine learning model 135 and processing of generating the learning data 136 a plurality of times, the learning accuracy of the machine learning model 135 is further improved. As described above, since the learned model 1321 is larger in scale than the learned model 1311, the accuracy of the learned model 1311 is improved faster at first. On the other hand, when the updating of the learned models 1311 and 1321 and the generation of the learning data 136 are repeated, the accuracy of the learned model 1321 greatly increases. In response to this, more appropriate learning data 136 is obtained. As a result, the learning accuracy of the machine learning model 135 also tends to improve.

FIG. 5 is a flowchart illustrating a procedure of initial learning processing for obtaining a first learned model 1311. Here, a case where the initial learning processing is performed in the article acquisition and placement system 100 will be described.

In CPU11, one target part is held by the arm 62 (S1). The CPU11 causes the arm 62 to hold the target part at the set position and orientation by the drive section 61 (S2). At this time, the background of the target part may be a plain surface or the like having no pattern. The orientation may be defined as, for example, each direction obtained by rotating the target part by a section angle within a certain angle range with respect to each of a first axis direction perpendicular to the imaging surface and a second axis direction parallel to the imaging surface. In one example, the angular range relative to the first axis direction may be ±45 degrees, the angular range relative to the second axis direction may be ±30 degrees, and the section angle may be 5 degrees, for example. The CPU11 causes the image capturer 50 to capture an image of the target part while changing the orientation of the target part in this way, and acquires the captured image (S3).

The CPU11 detects a range of the target part from the captured image and acquires an outline mask (S4). As described above, the detection of the range of the target part may be performed by any of various simple detection algorithms different from the machine learning model. The inside of the detected closed boundary line is set as a outline mask. The CPU11 generates initial learning dataset from a set of the captured image and the outline mask (S5).

The CPU11 determines whether the target part has been imaged in all of the set directions (S7). When it is determined that the target part has not been imaged in all directions, that is, there is an angular direction in which the target part has not been imaged (S6; N), the processing in CPU11 returns to step S2. If it is determined that the target part has been imaged in all of the set directions (Y in S6), CPU11 causes the machine learning model of the first extraction section 131 to perform initial learning with the obtained multiple datasets for initial learning data (S7).

In CPU11, errors in the learned machine learning model are evaluated to determine whether the errors are equal to or smaller than a reference (S8). If it is determined that the error is not equal to or less than the reference (N in S8), the processing in CPU11 returns to step S1. That is, the CPU11 additionally images another target part and generates initial learning dataset.

When it is determined that the error is equal to or less than the reference (S8; Y), CPU11 registers the obtained learned model as the learned model 1311 of the first extraction section 131 (S9). Then, the CPU1l ends the initial learning processing.

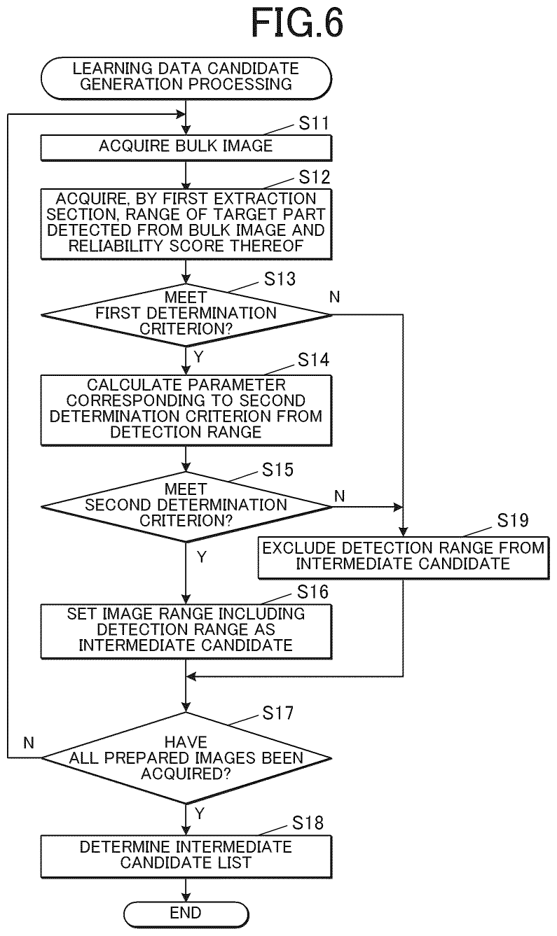

FIG. 6 is a flowchart illustrating a procedure of learning data candidate generation processing. This processing corresponds to the first extraction processing P1, the first determination processing P2, and the second determination processing P3 described above.

The CPU11 acquires a bulk image including the target part (S11). The CPU11 detects the target part from the acquired bulk image by the first extraction section 131, and acquires the detection range and its reliability score (S12; first extraction means). The CPU11 determines whether or not the reliability score satisfies the first determination criterion 137 (S13; first determination means).

When it is determined that the reliability score does not satisfy the first determination criterion 137 (S13; N), CPU11 excludes the detection range from the intermediate candidates (S20). Then, the CPU11 treatment proceeds to step S17. If the reliability score is determined to satisfy the first determination criterion 137 (S13; Y), the CPU11 analyzes the image in the detection range and calculates parameters according to the second determination criterion (S14). As described above, the parameter may be, for example, a value related to the size of the detection range, for example, the number of pixels. The CPU11 determines whether or not the detection range satisfies a second determination criterion (S15; second determination means).

If it is determined that the detection range does not satisfy the second determination criterion (S14; N), the CPU11 processing proceeds to step S20. If the detection range is determined to satisfy the second determination criterion (S14; Y), CPU11 sets an image range of a predetermined size including the detection range as an intermediate candidate (S16). Then, the CPU11 treatment proceeds to step S17.

In the process S17, the CPU11 determines whether all the prepared bulk images have been acquired (S17). In a case where it is determined that not all the bulk images have been acquired, that is, there is an image that has not been acquired (S17; N), the CPU11 processing returns to step S11. If it is determined that all the bulk images have been acquired (S17; Y), CPU11 sets a list of set intermediate candidates and collectively stores and holds the list (S18). Then, the CPU11 ends the learning data candidate generation processing.

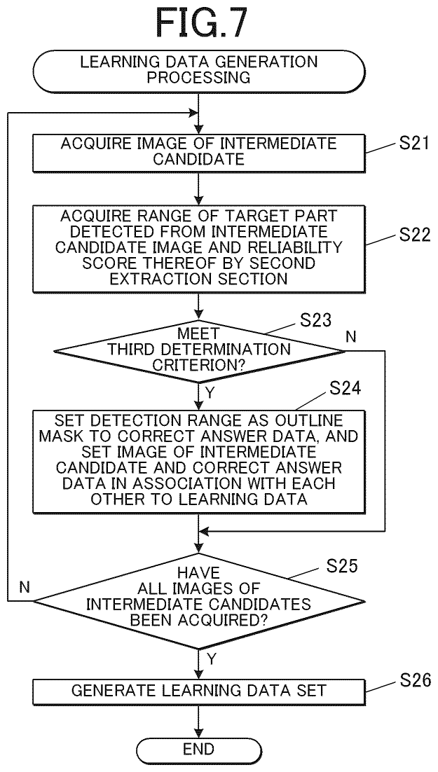

FIG. 7 is a flowchart illustrating a control procedure of learning data generation processing. This processing is performed after the learning data candidate generation processing. This processing corresponds to the above-described second extraction processing P4 and third determination processing P5.

The CPU11 acquires an image of an intermediate candidate from the intermediate candidate list (S21). The CPU11 detects, by the second extraction section 132, the range of the target part from the acquired image of the intermediate candidate, and acquires the reliability score thereof (S22; second extraction means).

The CPU11 determines whether or not the reliability score satisfies the third determination criterion 139 (S23; third determination means). In a case where it is determined that the reliability score does not satisfy the third determination criterion 139 (S23; N), the process of CPU11 proceeds to step S25. If it is determined that the reliability score satisfies the third determination criterion 139 (S23; Y), CPU11 sets the detected range to correct answer data as an outline mask. CPU11 associates the correct answer and the intermediate candidate image with each other and sets them as learning datasets (S24). Then, the CPU11 treatment proceeds to step S25.

In step S25, CPU11 determines whether all the images of the intermediate candidate have been acquired (S25). When it is determined that all the intermediate candidate images have not been acquired, that is, there is an intermediate candidate image that has not been acquired (S25; N), the CPU11 processing returns to the step S21. If it is determined that all the images of the intermediate candidates have been acquired (S25; Y), CPU11 generates a learning dataset in which the set groups of learning datasets are grouped (S26). Then, the CPU11 ends the learning data generation processing.

Steps S24 and S26 correspond to the learning data generating means of the present embodiment.

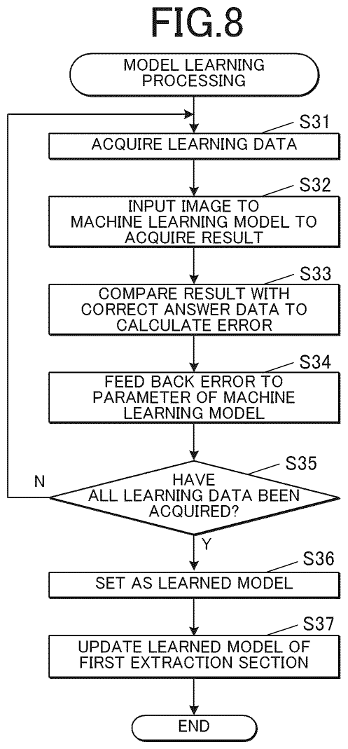

FIG. 8 is a flowchart illustrating a control procedure of model learning processing for learning the machine learning model 135. This processing is executed after the learning data set is generated by the learning data generation processing.

The CPU11 acquires unacquired learning dataset from the learning dataset (S31). CPU11 inputs the acquired learning data image to the machine learning model 135, and acquires the output result (S32). The CPU11 calculates errors by comparing the acquired results with the correct answer (S33).

The CPU11 feeds back the errors to the parameters of the machine learning model 135 (S34). An appropriate loss function may be used for the calculation of the error. The feedback may be performed by a conventionally well-known method, for example, a (error) back propagation method.

The CPU11 determines whether all the learning datasets have been acquired (S35). If not all the learning datasets have been acquired, that is, if it is determined that there is an unacquired learning dataset (N in S35), the CPU11 processing returns to step S31. If all the learning datasets have been acquired (Y in S35), CPU11 assigns the learned machine learning model 135 as a learned model (S36). The CPU11 updates the learned model 1311 of the first extraction section 131 with the learned model (S37). Then, the CPU11 ends the model learning processing.

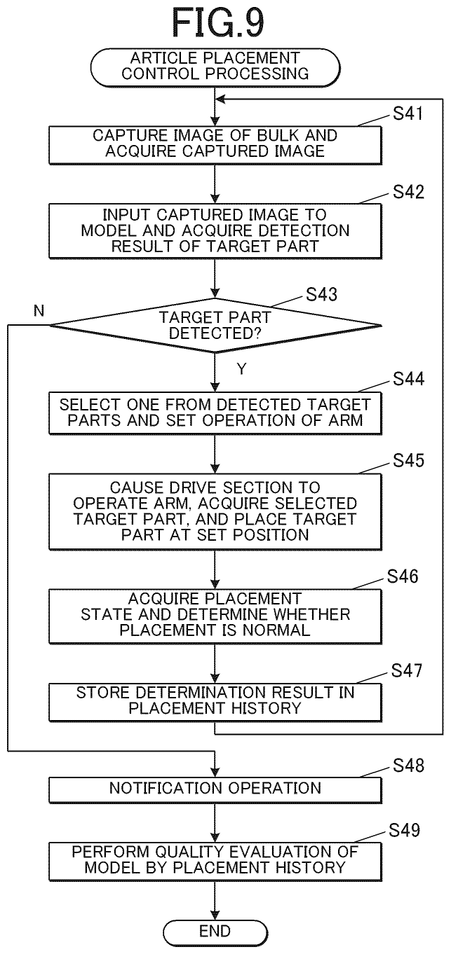

FIG. 9 is a flowchart illustrating a control procedure of article placement control processing by an obtained learned model. This processing is used for actual operation of the article acquisition and placement system 100. CPU11 causes the image capturer 50 to capture an image of the bulk and acquires the captured image (S41). The CPU11 inputs the acquired captured image to the learned model, and acquires a detection result of the range of the target part (S42).

The CPU11 determines whether or not a target part has been detected (S43). When it is determined that the target part is detected (S43; Y), the CPU11 selects one of the detected target parts, and sets the position and orientation to be gripped by the arm 62 in accordance with the position and orientation of the selected target part (S44). The CPU11 causes the drive section 61 to operate the arm 62 in accordance with the setting to acquire the selected target part. The CPU11 causes the arm 62 to place the acquired target part at the set position in the set orientation (S45).

The CPU11 acquires information on the state in which the target part has been moved to the set position, and determines whether or not the target part has been appropriately placed (S46; state determination means). The CPU11 may include, for example, an image capturer that captures an image of the setting position. The CPU11 causes the storage section 13 to store the determination result as an placement history (S47). Note that the target part that has not been accurately placed may be corrected and placed by another processing. Further, the captured image of the bulk in the case where the images are not accurately placed may be stored in the storage section 13 as a determination failure image. The determination failure image may be repeatedly included in the images acquired in the step S11 of the learning data candidate generation processing until the first determination criterion 137 to the third determination criterion 139 are satisfied. Then, the processing of the CPU11 returns to the process S41.

In a case where it is determined that the target part is not detected in the determination processing in the step S43 (S43; N), CPU11 causes the display part 15 or another notification operation part to perform a notification operation indicating that there is no target part to be acquired (S48). The CPU11 analyzes the placement history stored in the storage section 13, calculates the accuracies of the learned models, and determines and evaluates the qualities thereof (S49; accuracy determination means). The result of the evaluation is stored in the storage section 13. In addition, the evaluation result may be outputted for display by the display part 15, or may be outputted to the outside as data or a print as a report. Next, the CPU1l ends the article placement control processing.

As described above, the information processing device 10 as the learning data generation support device of the present embodiment includes the CPU11. The CPU11 causes the first extraction section 131 of the program 130 to extract a first extraction region corresponding to the detection target from the captured image including the detection target. The CPU11, as first determination means, determines the certainty that the first extraction region is accurate. The CPU11, as second determination means, determines the certainty of the first extraction region determined to have certainty equal to or higher than the reference from a viewpoint different from that of the first determination means. The CPU11 extracts, from the captured image including the first extraction region whose certainty is determined by the second extraction section 132 of the program 130 to be equal to or higher than the reference, the second extraction region corresponding to the detection target, by a method different from that of the first extraction section 131. Here, the structure of the second extraction section 132 is different from the structure of the first extraction section 131. The CPU11, as third determining means, determines the certainty that the second extraction region is accurate. The CPU11, as the learning data generating means, determines the second extraction region whose certainty is determined by the third determining means to be equal to or greater than the reference as the learning data of the machine learning model for extracting the detection target.

Therefore, the information processing device 10 can obtain correct answer data with less manpower. As a result, the information processing device 10 can easily make the accuracy levels of the correct answer data uniform. Therefore, learning data can be generated more easily, and the machine learning model can be made to learn appropriately.

Further, the CPU11 as the second determination means may determine the certainty of the first extraction region based on a visual shape feature of the detection target. That is, for the learned model 1311 at an insufficiently learned stage, another determination method that does not use a machine learning model is used in combination. As a result, the information processing device 10 can match the level of the discrimination accuracy while reducing a decrease in the discrimination accuracy of the target part.

The CPU11 as the second determiner may determine the certainty of the second extraction region on the basis of the size of the detection target. If the detection target is an article of a fixed size, the size information can be an important determination condition. On the other hand, since the three dimensional orientation of the target article is not fixed, the captured image may be obtained in a slightly inclined state or a part of the target article may overlap with another article. Therefore, the information processing device 10 can easily and clearly exclude, as erroneous extraction, the first extraction regions obviously having different sizes, on the basis of the size of the detected object in the captured image.

Further, the CPU11 as the second determination means may determine the certainty of the second extraction region by using pattern matching of the shape of the detection target or edge detection. Since the article to be the detection target is fixed, the outline and the shape characteristics of the inside of the outline are determined. Therefore, by using a technique for easily extracting these, the information processing device 10 can add information regarding a clear structural difference to an extraction result of a learned model for which learning is insufficient.

Furthermore, in the processing performed by the first extraction section 131, the CPU11 may use a machine learning model having the same structure as the machine learning model 135. The CPU11 extracts the first extraction regions based on the probability distributions to be the detection target by the learned model 1311 of the machine learning model. The CPU11 as the first determination section may determine the certainty of the first extraction region based on the obtained probability distributions. That is, the information processing device 10 can obtain learning data with higher accuracy by using another method in combination for the learned model 1311 at a certain stage of the machine learning model 135 to be learned. Thus, the accuracy of the machine learning model 135 can be more improved than the original learned model 1311 without human intervention in the generation of correct answer data.

Further, the CPU11 as the first extraction means may acquire a learned model of the machine learning model 135 learned by the obtained learning data 136 and use it as the learned model 1311. The CPU11 may extract the first extraction region using the learned model 1311. That is, the learning data 136 is generated and the machine learning model 135 is learned, whereby the learned model 1311 is improved to a more accurate learned model without human intervention in the generation of correct answer data.

The information processing device 10 according to the present embodiment may perform a set of generation of learning data and learning of a machine learning model a plurality of times. The CPU11 as the first extraction section may update the learned model 1311 by acquiring the learned model for each learning of the machine learning model 135. At the time of extracting the first extraction region for the first time, an initial model learned on the basis of a captured image of one detection target may be used. Even in a case of gradually improving the learned model 1311, it is necessary to prepare the initial learned model 1311 for which the machine learning model 135 has not been learned. In the present disclosure, since the target article is originally fixed, the target article can be learned to a detectable level by itself, not in bulk, without the need for machine learning. At this level of learning, correct answer data is obtained by simple image processing without human intervention, and consequently the learning accuracy of the machine learning model 135 is improved without human intervention in the generation of correct answer data.

Furthermore, the visual shape feature may be determined based on a captured image of one detection target. That is, the visual shape feature used for the second determination criterion 138 different from the learned model may be determined based on the captured image of a single detection target article. Thus, the reference of the visual shape feature is also accurately obtained with as little human intervention as possible.

Further, the CPU11 as the second extraction means may determine, as the input image, a range of the captured image with reference to at least the position of the centroid of the first extraction region. The second extraction section 132 may cut out and learn an appropriate range including the target article from the bulk images. At this time, since the size of the cutout image is determined with reference to the position of the centroid of the target article, an appropriate image range is accurately and easily determined regardless of the orientation, the inclination, or the like of the target article.

In addition, the CPU11 as the first extraction means may extract the first extraction region and set a classification related to the detection target. In this case, the CPU11 as the second extraction means may extract the second extraction region and set the classification related to the detection target. The information processing device 10 can not only determine the range of the target article from the mere image but also obtain, as additional information, type information such as the state of the target article. Thus, the information processing device 10 can improve the accuracy of determining the target article from the bulk.

Furthermore, the classification may include information on the front and back of the detection target. In bulk, the front side of the target article may be photographed or the back side thereof may be photographed. It may be necessary to specify the front and back so that the operation of the movement placement section 60 varies depending on which face is located on the front side. The information processing device 10 can more easily and appropriately handle the target article related to the extracted region by the additional information indicating the classification of the front and back.

Furthermore, the CPU11 may be able to extract extraction regions related to a plurality of types of detection targets by the first extraction section 131 and the second extraction section 132. In this case, the classification may include a plurality of types of identification information. That is, the target article to be the detection target may not be of one type. In this case, including information identifying the extracted target article as the additional information allows the information processing device 10 to more easily and appropriately handle the target article associated with the extracted region.

In addition, the information processing device 10 as the movement controller of the present embodiment includes a learned model obtained by learning using the generated learning dataset and a CPU11. The CPU11 extracts a detection target article using a learned model obtained by causing the machine learning model 135 to learn from a captured image of a bulk of a plurality of articles captured by the image capturer 50. The CPU11 causes the movement placement section 60 to acquire the article related to the extracted region from the bulk and move the article to the specified position. Such an information processing device 10 can accurately obtain the target article loaded in bulk, including information on the position and orientation thereof. Therefore, the information processing device 10 can more appropriately control the operation of the movement placement section 60 that actually moves the target article while reducing time and effort for learning of the machine learning model 135.

Furthermore, the CPU11 of the information processing device 10 may acquire, as state determination means, information on the state in which the target article has been moved by the movement placement section 60. Furthermore, the CPU11 may determine the state of the moved target article, that is, whether or not the position, the orientation, and the front and back are appropriate. Furthermore, the CPU11 may be able to determine, as accuracy determination means, the accuracy of the machine learning model 135 after learning on the basis of the above-described determination result. By such a determination at the time of operation, the information processing device 10 can determine whether the machine learning model 135 has been learned with a practically usable accuracy, and can determine the necessity of improvement thereof.

In addition, the article acquisition and placement system 100 of the present embodiment includes the information processing device 10 as the movement controller, the image capturer 50, and the movement placement section 60. The image capturer 50 photographs the bulk to obtain a captured image. Under the control of the information processing device 10 based on the captured image, the movement placement section 60 acquires the article to be the detection target from the bulk and moves the article to the specified position. According to such an article acquisition and placement system 100, it is possible to improve the accuracy of moving a target article from bulk to a desired position more easily.

The article acquisition and placement system 100 according to the present embodiment includes the information processing device 10, the movement placement section 60, and the image capturer 50. The information processing device 10 includes a CPU11 and a machine learning model 135 learned using the learning dataset 136 generated as described above. The CPU11 extracts, using the machine learning model 135, an article to be the detection target from a captured image of a bulk of a plurality of articles captured by the image capturer 50. The CPU11 causes the arm 62 to acquire the extracted article from the bulk and move the article to a specified position.

The CPU11 may cause the image capturer 50 to capture an image of an article to be the detection target that has been acquired from bulk while causing the movement placement section 60 to change the orientation of the article relative to the image capturer 50. The CPU11 may obtain an initial model of the learned model 1311 on the basis of the obtained captured images in the plurality of orientations. The article acquisition and placement system 100 can perform an operation of aligning the orientations of the individual articles by the arm 62. Using this, conversely, the CPU11 may be able to cause the image capturer 50 to capture an image of an individual article while changing the orientation of the article. Accordingly, the article acquisition and placement system 100 can easily obtain the learning data for generating the initial model of the learned model 1311.

A learning data generation support method according to the present embodiment includes the following steps. (1) First extraction of extracting a first extraction region corresponding to a detection target from a captured image including the detection target. (2) First determining to determine certainty that the first extraction region is accurate. (3) A second determination of determining the certainty, from a viewpoint different from that of the first determination means, of the first extraction region determined by the first determination means to have certainty equal to or greater than the reference. (4) Second extraction of extracting a second extraction region corresponding to the detection target from the captured image including the first extraction region whose certainty is determined to be the reference or higher by the second determination means, by a method different from that of the first extraction means. (5) Third determining to determine certainty that the second extraction region is accurate. (6) Learning data generation of defining the second extraction region determined to have certainty equal to or higher than the reference by the third determination means as learning data of a machine learning model for extracting the detection target. According to such a learning data generation support method, it is possible to obtain correct answer data for learning data of the machine learning model 135 that extracts target articles from bulk without more manpower. As a result, the accuracy level of correct answer data in the learning data can be easily equalized. Therefore, by using this learning data generation support method, learning data can be generated more easily and the machine learning model can be caused to learn appropriately.

The program 130 according to the above-described learning data generation support method can be easily installed on a computer. By executing the program 130, correct answer data of the learning data 136 can be acquired by software processing using an ordinary electronic computer with less manpower.

Note that the present invention is not limited to the embodiment described above, and various modifications can be made.

For example, the first extraction section 131 may not have a machine learning model in an initial state. Once the machine learning model 135 to be learned has been learned and a learned model has been obtained, the learned model may be set as the learned model 1311 in the first extraction section 131.

Further, the learning data of the initial model of the learned model 1311 may be obtained outside the article acquisition and placement system 100. Alternatively, the initial model itself of the learned model 1311 may be generated outside the article acquisition and placement system 100.

In the above description, the target article is a part of a certain configuration, but the present invention is not limited thereto. The above technique may be used for sorting and alignment of target articles. Furthermore, it may be used at other than the manufacturing site such as a factory. Alternatively, the detection target of the machine learning model 135 may not be the article in the captured image. Further, the captured image may not be a visible light image.

In the above description, an example of extracting a target article having plate-like front and back surfaces has been described, but the present invention is not limited thereto. It may have a more steric structure.

Alternatively, in a case where the structures of the front and back are symmetrical and the distinction between the front and back is unnecessary, the classification between the front and back may not be performed.

Furthermore, although the image range based on the centroid of the first extraction region is set as the input range of the second extraction means in the above description, it is not limited thereto. The reference position and the range may be determined such that the first extraction region is appropriately included.

In addition, learning and updating of the learned model 1321 may be performed at a frequency or timing different from learning and updating of the learned model 1311. It is sufficient that learning and updating are performed at the timing at which the necessary learning data is collected.

Further, the second determination process P3 may be performed by a method other than pattern matching or edge detection.

Furthermore, in the above description, the reliability score is used as the determination criterion of the first determination section and the third determination section, but it is not limited thereto. Other parameters may be used to determine the certainty.

Further, the quality evaluation of the machine learning model 135 performed in FIG. 9 may be performed by a configuration outside the article acquisition and placement system 100. That is, an image capturer and an information processing device for quality evaluation may be present separately from the article acquisition and placement system 100 to perform quality evaluation.

Further, in the article acquisition and placement system 100, the information processing device 10, the image capturer 50, and the movement placement section 60 may be integrated, or originally separate configurations may be combined. An environment for mobile use, for example, Jetson® may be used for the information processing device 10. Furthermore, the information processing device 10 may have different configurations as the learning data generation support device and as the movement controller.

In the above description, the storage section 13 including a non-volatile memory such as an HDD or a flash memory has been described as an example of a computer-readable medium that stores the program 130 according to the generation control of the correct answer data of the invention, but the present invention is not limited thereto. As other computer-readable media, other nonvolatile memories such as an MRAM and portable recording media such as a CD-ROM and a DVD disk can be applied. As a medium for providing data of the program according to the present invention via a communication line, a carrier wave is also applied to the present invention.

In addition, the specific configurations, the contents and procedures of the processing operations, and the like described in the above embodiment can be appropriately changed without departing from the spirit and scope of the present invention. It is intended that the scope of the present invention includes the scope of the invention described in the scope of the claims and the scope of equivalents thereof.

Although embodiments of the present invention have been described and shown in detail, the disclosed embodiments are made for purposes of illustration and example only and not limitation. The scope of the present invention should be interpreted by terms of the appended claims.

The entire disclosure of Japanese Patent Application No. 2024-073498 filed on Apr. 30, 2024 is incorporated herein by reference in its entirety.

What is claimed is:

1. A learning data generation support device, comprising a hardware processor that:
extracts a first extraction region corresponding to a detection target from a captured image including the detection target;
determines a certainty that the first extraction region is accurate;
determines the certainty with respect to the first extraction region determined to have the certainty equal to or higher than a reference from a different viewpoint from a viewpoint from which the certainty that the first extraction region is accurate is determined;
extracts, from a captured image including the first extraction region determined to have the certainty equal to or higher than the reference from the different viewpoint, a second extraction region corresponding to the detection target by a method different from a method by which the first extraction region is extracted;
determines a certainty that the second extraction region is accurate; and
determines the second extraction region which is determined to have the certainty equal to or higher than a reference as learning data of a machine learning model for extracting the detection target.

2. The learning data generation support device according to claim 1, wherein the hardware processor determines the certainty of the first extraction region based on a visual shape feature of the detection target.

3. The learning data generation support device according to claim 1, wherein the hardware processor determines the certainty of the second extraction region based on a size of the detection target.

4. The learning data generation support device according to claim 1, wherein the hardware processor determines the certainty of the second extraction region using pattern matching or edge detection of a shape of the detection target.

5. The learning data generation support device according to claim 1, wherein the hardware processor extracts the first extraction region based on probability distribution which is the detection target using a machine learning model having a same structure as a structure of the machine learning model, and determines the certainty of the first extraction region based on the probability distribution.

6. The learning data generation support device according to claim 5, wherein the hardware processor acquires a learned model of the machine learning model learned by the learning data and extracts the first extraction region using the learned model.

7. The learning data generation support device according to claim 6, wherein
a set of generation of the learning data and learning of the machine learning model is performed a plurality of times, and
the hardware processor acquires and updates the learned model for each learning, and uses an initial model learned based on a captured image of one of the detection target when the first extraction region is extracted for a first time.

8. The learning data generation support device according to claim 7, wherein
the hardware processor determines the certainty of the first extraction region based on a visual shape feature of the detection target, and
the shape feature is defined based on a captured image of the one of the detection target.

9. The learning data generation support device according to claim 1, wherein the hardware processor sets, as an input image, at least a range with reference to a centroid position of the first extraction region in the captured image.

10. The learning data generation support device according to claim 1, wherein the hardware processor extracts the first extraction region, and sets a classification related to the detection target, and extracts the second extraction region, and sets a classification related to the detection target.

11. The learning data generation support device according to claim 10, wherein the classification includes information on front and back of the detection target.

12. The learning data generation support device according to claim 10, wherein the hardware processor is capable of extracting extraction regions related to a plurality of types of the detection target, and the classification includes the plurality of types of identification information.

13. A movement controller comprising:
a learned model obtained by learning using learning data generated by the learning data generation support device according to claim 1; and
a hardware processor, wherein
the hardware processor extracts, using the learned model, an article of the detection target from a captured image of a bulk of a plurality of articles captured by an image capturer, and causes a movement operator to acquire the extracted article from the bulk and move the article to a specified position.

14. The movement controller according to claim 13, wherein the hardware processor acquires information about a moved state, determines whether or not the state is appropriate according to the detection target, and
determines an accuracy of the learned model based on a determination result of whether or not the state is appropriate according to the detection target.

15. An article acquisition and placement system comprising:
the movement controller according to claim 13;
an image capturer that images the bulk to obtain the captured image; and
a movement operator that, in response to control of the movement controller based on the captured image, acquires an article of the detection target from the bulk and moves the article to the specified position.

16. An article acquisition and placement system comprising:
a movement controller comprising: a learned model obtained by learning using learning data generated by the learning data generation support device according to claim 7; and a hardware processor, wherein the hardware processor extracts, using the learned model, an article of the detection target from a captured image of a bulk of a plurality of articles captured by an image capturer, and causes a movement operator to acquire the extracted article from the bulk and move the article to a specified position;
an image capturer that images the bulk to obtain the captured image; and
a movement operator that, in response to control of the movement controller based on the captured image, acquires the article of the detection target from the bulk and moves the article to the specified position,
wherein
the hardware processor obtains the initial model based on a captured image obtained by causing the image capturer to image while changing, with the movement operator, an orientation relative to the image capturer of the article of the detection target acquired from the bulk.

17. A learning data generation support method comprising:
first extracting that is extracting, from a captured image including a detection target, a first extraction region corresponding to the detection target;
first determining that is determining a certainty that the first extraction region is accurate;
second determining that is determining, for the first extraction region for which the certainty is determined to be equal to or more than a reference in the first determining, a certainty from a different viewpoint from the first determining;
second extracting that is extracting, from a captured image including the first extraction region for which the certainty is determined to be equal to or more than the reference in the second determining, a second extraction region corresponding to the detection target by a method different from the first extracting;
third determining that is determining a certainty that the second extraction region is accurate; and
learning data generating that is determining the second extraction region determined to have the certainty equal to or higher than a reference in the third determining as learning data of a machine learning model for extracting the detection target.

18. A non-transitory recording medium storing a computer-readable program causing a computer to perform:
first extracting that is extracting, from a captured image including a detection target, a first extraction region corresponding to the detection target;
first determining that is determining a certainty that the first extraction region is accurate;
second determining that is determining, for the first extraction region for which the certainty is determined to be equal to or more than a reference in the first determining, a certainty from a different viewpoint from the first determining;
second extracting that is extracting, from a captured image including the first extraction region for which the certainty is determined to be equal to or more than the reference in the second determining, a second extraction region corresponding to the detection target by a method different from the first extracting;
third determining that is determining a certainty that the second extraction region is accurate; and
learning data generating that is determining the second extraction region determined to have the certainty equal to or higher than a reference in the third determining as learning data of a machine learning model for extracting the detection target.
